(19) United States
(12) Patent Application Publication
(10) Pub. No.: US 2002/0178357 A1
(43) Pub. Date: Nov. 28, 2002

(54) Electronic lock arrangement

(76) Inventor: Wang Ming Cheng, Taipei City (TW)

Correspondence Address: WANG Ming Cheng, P.O. Box 82-144, Taipei, TW

(21) Appl. No.: 09/864,199

(22) Filed: May 25, 2001

(51) Int. Cl. H04L 9/00

(52) U.S. Cl. 713/159

(57) ABSTRACT

An electric lock arrangement includes a circuit board installed in the mouse of a computer, the circuit board having a plurality of interface connectors, each interface connector having an insertion slot electrically connected to the internal circuit of the mouse and two upright spring rods at two sides of the insertion slot, the upright spring rods each having a horizontally inwardly extended rounded protruding portion, and an encryption card for insertion into one interface connector to provide a code signal to the computer for enabling the computer to copy a coded software, the encryption card having two rounded retaining recesses respectively disposed in two opposite vertical sidewalls thereof and adapted to receive the horizontally inwardly rounded extended protruding portion of each of the upright spring rods of one interface connector, and a plug unit for insertion into the insertion slot of one interface connector to electrically connect the encryption card to the mouse and the computer.

### BACKGROUND OF THE INVENTION

The present invention relates to the arrangement of an electronic lock and, more particularly to such an electronic lock arrangement, in which an electronic lock is installed in the mouse of a computer to protect encrypted computer program against pirating. The user can change the encryption code of the electronic lock or expand the electronic lock easily to fit different programs.

Developing a new product takes much time and consumes much labor and money. When a new product developed, it must be well protected against infringement or pirating. Patent and copy writes provide protection to registered industrial products and artworks. Further, computer software creators commonly encrypt the developed software with an encryption code to protect the software from pirating. However, after installation of an encrypted software program in a computer, other people can easy copy the software program from the computer illegally. Nowadays, various electronic locks have been disclosed for use to lock a computer, preventing others from using the computer. These electronic locks are functional, however they cannot prohibit others from pirating the software programs installed in the computer during the time interval where the user temporarily went away from the computer.

### SUMMARY OF THE INVENTION

The present invention has been accomplished under the circumstances in view. It is the main object of the present invention to provide an electronic lock arrangement, which is installed in the mouse of a computer to prohibit other people from pirating the software of the computer. It is another object of the present invention to provide an electronic lock arrangement, which enables the user to copy the software of the computer only when the assigned encryption card is inserted into the corresponding interface connector in the mouse of the computer. It is still another object of the present invention to provide an electronic lock arrangement, which enables the user to take the assigned encryption card away from the interface connector when leaving from the computer, prohibiting other people from pirating the corresponding encrypted software of the computer. It is still another object of the present invention to provide an electronic lock arrangement, which enables the user to lock/unlock multiple software programs. To achieve these and other objects of the present invention, the electric lock arrangement comprises a circuit board installed in the mouse of a computer, the circuit board having a plurality of interface connectors, each interface connector having an insertion slot electrically connected to the internal circuit of the mouse and two upright spring rods at two sides of the insertion slot, the upright spring rods each having a horizontally inwardly extended rounded protruding portion, and multiple encryption cards for insertion into the interface connectors to provide a respective code signal to the computer for enabling the computer to copy a respective encrypted software, each encryption card having two rounded retaining recesses respectively disposed in two opposite vertical sidewalls thereof and adapted to receive the horizontally inwardly rounded extended protruding portion of each of the upright spring rods of one interface connector, and a plug unit for insertion into the insertion slot of one interface connector to electrically connect the encryption card to the mouse and the computer.

### BRIEF DESCRIPTION OF THE DRAWINGS

FIG. 1 illustrates a circuit board provided with multiple interface connectors and installed in an optical mouse and an encryption card for connection to one of the interface connectors according to the present invention.

FIG. 2 is an exploded view of an interface connector and an encryption card according to the present invention.

FIG. 3 is a flow chart explaining the electronic locking circuit matched with the internal circuit of the computer mouse to lock the internal software of the computer according to the present invention.

FIG. 4 is a flow chart explaining the unlocking procedure of the present invention.

### DETAILED DESCRIPTION OF THE PREFERRED EMBODIMENT

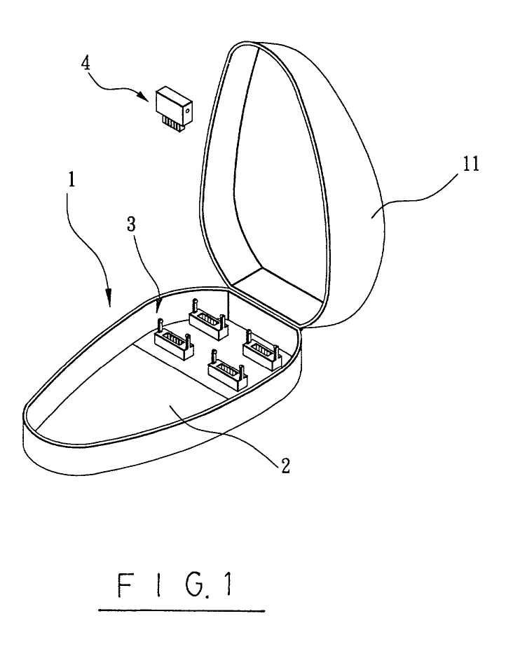

Referring to FIG. 1, the electronic lock arrangement of the present invention is shown comprising a circuit board 2 mounted inside an optical mouse 1, the circuit board 2 having an interface connector 3, and an encryption card 4 plugged into the interface connector 3. After installation of the encryption card 4, the cover shell 11 of the mouse 1 is closed.

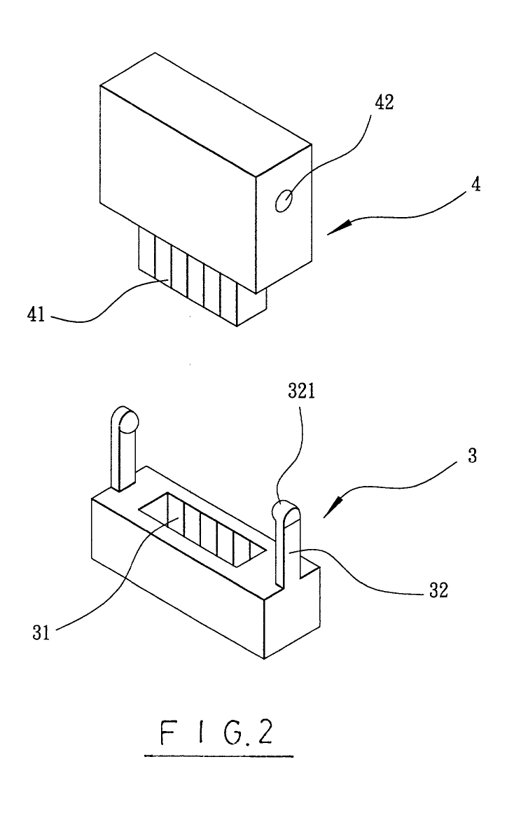

Referring to FIG. 2, the interface connector 3 comprises an insertion slot with electrically conducting terminals 31, and two upright spring rods 32 perpendicularly extended from the top sidewall thereof at two sides of the insertion slot with electrically conducting terminals 31. The upright spring rods 32 each have a horizontally inwardly extended rounded protruding portion 321. The encryption card 4 comprises two rounded retaining recesses 42 respectively disposed in two opposite vertical sidewalls thereof and adapted to receive the horizontally inwardly extended rounded protruding portion 321 of each of the upright spring rods 32, and a plug unit with electrically conducting terminals 41 for insertion into the insertion slot with electrically conducting terminals 31. After insertion of the plug unit with electrically conducting terminals 41 into the insertion slot with electrically conducting terminals 31, the electrically conducting terminals of the plug unit 41 are respectively forced into contact with the respective electrically conducting terminals of the insertion slot 31 to transmit the pre-set signal, and the horizontally inwardly extended rounded protruding portion 321 of each of the upright spring rods 32 is respectively forced into engagement with the rounded retaining recesses 42 of the encryption card 4 to positively secure the encryption card 4 in position. Because the protruding portion 321 has a rounded surface fitting the rounded retaining recess 42, the encryption card 4 can be directly pulled out of the interface connector 3 with force.

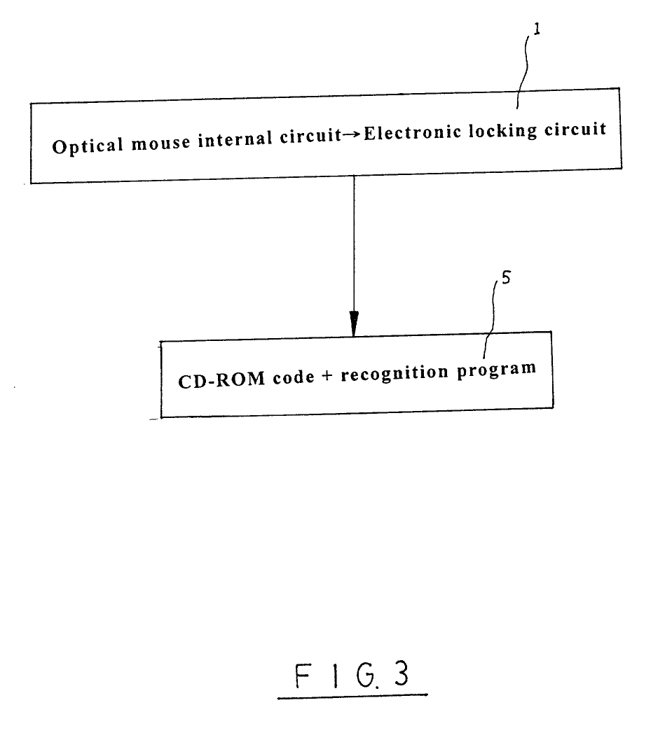

Referring to FIG. 3, the encryption card has an electronic encryption code circuit, which matches the internal circuit of the mouse 1 when inserted into the insertion slot with electrically conducting terminals of interface connector in the mouse 1. After installation, the user operates the computer 5, to which the mouse 1 is connected, to lock out the software in the computer 5. The code data of the electronic encryption code circuit includes “CD-ROM code” and “recognition program”.

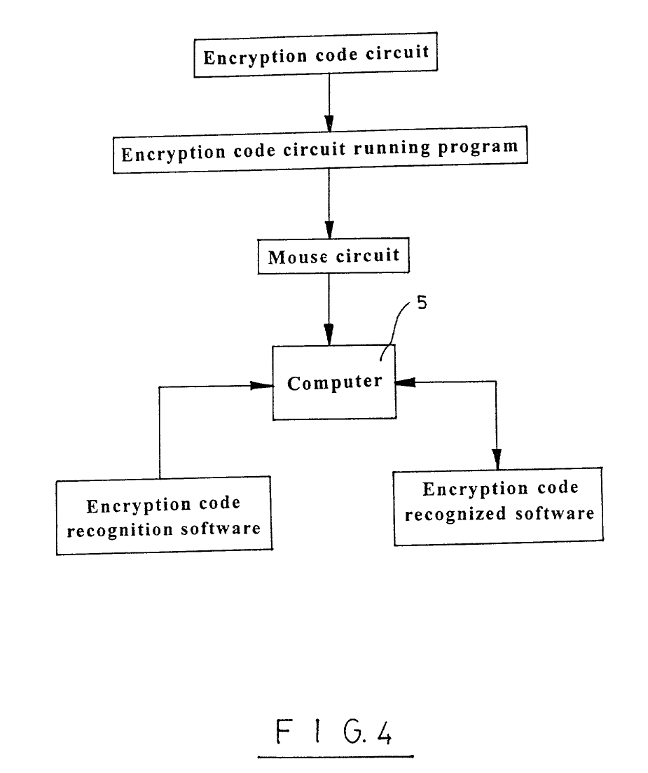

Referring to FIG. 4 and FIG. 1 again, when copying the software been locked out by the present invention, the user must insert the encryption card 4 into the interface connector 3, enabling the code data set in the encryption code circuit to be run by “encryption code circuit running program” of the circuit board 2 and inputted into the computer 5 through the mouse 1, and then the user must let the CD-ROM (or floppy disk) carrying “recognition code software” be inserted into the CD-ROM player (or floppy diskdrive) for reading, so that the computer can start copying the software after the code of the encryption card 4 has been recognized by a code recognition software run by the computer 5. On the contrary, if the code does not match, the computer 5 is prohibited from running the copying procedure. When leaving, the encryption card 4 is removed from the mouse 1, preventing others from copying the encrypted software.

A prototype of electronic lock arrangement has been constructed with the features of FIGS. 1-4. The electronic lock arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electric lock arrangement comprising a circuit board mounted inside an optical mouse and electrically connected to the internal circuit of the optical mouse for signal transmission to the computer to which the optical mouse is connected, said circuit board comprising at least one interface connector, said at least one interface connector comprising an insertion slot electrically connected to the internal circuit of the optical mouse, and two upright spring rods perpendicularly extended from a top sidewall thereof at two sides of said insertion slot, said upright spring rods each having a horizontally inwardly extended protruding portion, and an encryption card for insertion into one of said at least one interface connector to provide a code signal to the computer for enabling the computer to copy a coded software, said encryption card comprising two retaining recesses respectively disposed in two opposite vertical sidewalls thereof and adapted to receive the horizontally inwardly extended protruding portion of each of the upright spring rods of one of said at least one interface connector, and a plug unit for insertion into the insertion slot of one of said at least one interface connector to electrically connect said encryption card to the optical mouse and the computer.

2. The electronic lock arrangement of claim 1 wherein the retaining recesses of said encryption card have a rounded shape, and the horizontally inwardly extended protruding portion of each of the upright spring rods of each of said at least one interface connector has a rounded shape fitting the rounded shape of the retaining recesses of said encryption card.
